(19) United States
(12) Patent Application Publication
(10) Pub. No.: US 2018/0086470 A1
(43) Pub. Date: Mar. 29, 2018

(54) HEATING DESIGN FOR ROTORCRAFT BLADE DE-ICING AND ANTI-ICING

(71) Applicant: Sikorsky Aircraft Corporation, Stratford, CT (US)

(72) Inventors: Wenping Zhao, Glastonbury, CT (US); Zaffir A. Chaudhry, South Glastonbury, CT (US); Jinliang Wang, Ellington, CT (US); Dean Nguyen, Greenwich, CT (US)

(21) Appl. No.: 15/555,216

(22) PCT Filed: Mar. 3, 2016
(86) PCT No.: PCT/US16/20625

§ 371 Date: Sep. 1, 2017

Related U.S. Application Data
(60) Provisional application No. 62/129,392, filed on Mar. 6, 2015.

(51) Int. Cl. B64D 15/12; B64C 27/473; F01D 5/28

(52) U.S. Cl. CPC B64D 15/12; B64C 27/473; F01D 5/282; H05B 3/36; F05D 2240/303; F05D 2300/603; B64C 2027/4736

(57) ABSTRACT

A heater mat assembly for a blade using an electrical current is provided including a first heating element region configured to generate a first amount of heat using the electrical current and disposed at a first region of the heater mat assembly. A second heating element region extends form the first heating element region and is configured to generate a second amount of heat using the electrical current. The second amount of heat is different than the first amount of heat.

### BACKGROUND OF THE INVENTION

The subject matter disclosed herein generally relates to an aircraft deicing system, and more particularly, to a deicing system for a rotor blade of a rotary wing aircraft.

Rotary wing aircrafts may encounter atmospheric conditions that cause the formation of ice on rotor blades and other surfaces of the aircraft. Accumulated ice, if not removed, can add excessive weight to the aircraft and may alter the airfoil configuration, causing undesirable flying characteristics.

A common approach to ice management is thermal deicing. Thermal deicing includes heating portions of the rotor blades, such as the leading edge for example, to loosen accumulated ice. Centrifugal forces acting on the rotor blades, and the airstream passing there over, remove the loosened ice from the rotor blades. Desired portions of the rotor blades are typically heated using electro thermal heating elements arranged at the leading edges of the airfoils, such as adjacent the blade spar, or underneath an anti-erosion metallic strip. As a result of this positioning, the electro thermal heating elements are not only subject to high bending stress, but are also susceptible to impact damage resulting in loss of functionality.

### BRIEF DESCRIPTION OF THE INVENTION

According to one embodiment of the invention, a heater mat assembly for a blade using an electrical current is provided including a first heating element region configured to generate a first amount of heat using the electrical current and disposed at a first region of the heater mat assembly. A second heating element region extends form the first heating element region and is configured to generate a second amount of heat using the electrical current. The second amount of heat is different than the first amount of heat.

In addition to one or more of the features described above, or as an alternative, in further embodiments the first heating element region has a first resistance and the second heating element region has a second resistance, the second resistance being different than the first resistance. The second resistance is different than the first resistance.

In addition to one or more of the features described above, or as an alternative, in further embodiments heat generated by the first and second heating element regions is configured to vary over at least one of a span and chord of the blade.

In addition to one or more of the features described above, or as an alternative, in further embodiments the first and second heating element regions are formed from a plurality of connected carbon nanotubes.

In addition to one or more of the features described above, or as an alternative, in further embodiments the heater mat assembly includes an insulating layer which separates the first and second heating elements regions from a portion of the blade spar to which the heater mat assembly is attachable.

In addition to one or more of the features described above, or as an alternative, in further embodiments the insulating layer is a woven glass/epoxy composite.

According to another embodiment of the invention, a rotor blade assembly is provided including a rotor blade having a rotor blade spar. A heater mat assembly is secured about a leading edge of the rotor blade and operated via an electrical current. The heater mat assembly includes a first heating element region configured to generate a first amount of heat using the electrical current and disposed at a first region of the heater mat assembly. A second heating element region extends form the first heating element region and is configured to generate a second amount of heat using the electrical current. The second amount of heat is different than the first amount of heat.

In addition to one or more of the features described above, or as an alternative, in further embodiments the first heating element region has a first resistance and the second heating element region has a second resistance, the second resistance being different than the first resistance. The second resistance is different than the first resistance.

In addition to one or more of the features described above, or as an alternative, in further embodiments heat generated by the first and second heating element regions is configured to vary over at least one of a span and chord of the blade.

In addition to one or more of the features described above, or as an alternative, in further embodiments the first and second heating element regions are formed from a plurality of connected carbon nanotubes.

In addition to one or more of the features described above, or as an alternative, in further embodiments the heater mat assembly includes an insulating layer which separates the first and second heating elements regions from a portion of the blade spar to which the heater mat assembly is attachable.

In addition to one or more of the features described above, or as an alternative, in further embodiments the heater mat assembly includes an a metal erosion strip and an insulating layer which separates the first and second heating elements regions from the metal erosion strip.

In addition to one or more of the features described above, or as an alternative, in further embodiments an adhesive is configured to couple the insulating layer to an adjacent surface of the metal erosion strip.

In addition to one or more of the features described above, or as an alternative, in further embodiments the insulating layer is a woven glass/epoxy composite.

In addition to one or more of the features described above, or as an alternative, in further embodiments an aircraft comprises the rotor blade assembly.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an embodiment of a rotary wing aircraft;

FIG. 2 is a perspective view of a rotor blade of a rotary wing aircraft including a heater mat assembly according to an embodiment of the invention;

FIG. 3 is a cross-sectional view of the heater mat assembly according to an embodiment of the invention; and

FIG. 4 is a perspective view of a partial cross-section of a rotor blade including a heater mat assembly according to an embodiment of the invention.

The detailed description explains embodiments of the invention, together with advantages and features, by way of example with reference to the drawings.

### DETAILED DESCRIPTION OF THE INVENTION

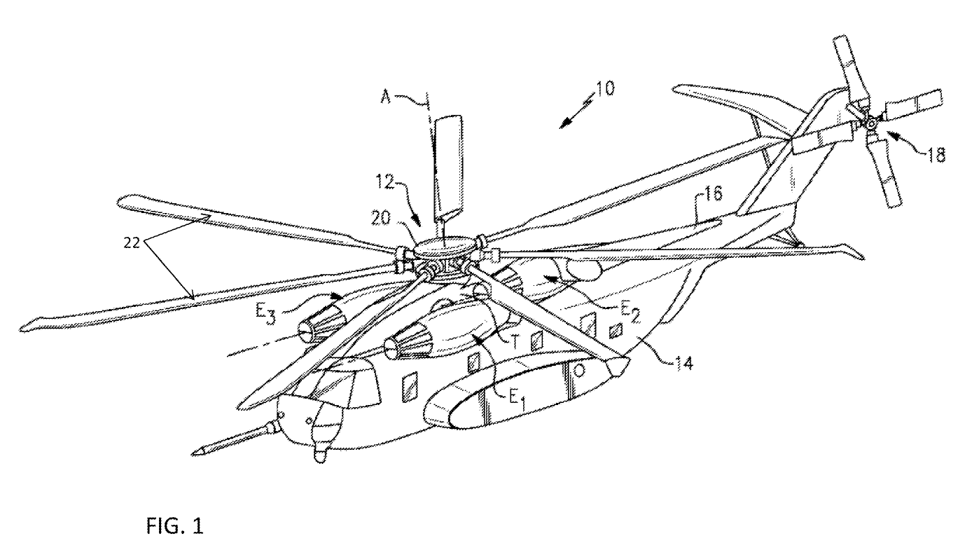

FIG. 1 schematically illustrates an example of a rotary wing aircraft 10 having a main rotor assembly 12. The aircraft 10 includes an airframe 14 having an extending tail 16 which mounts a tail rotor system 18. While shown as an anti-torque system, it is understood the tail rotor system 18 can be a translational thrust system, a pusher propeller, a rotor propulsion system, and the like in addition to or instead of the shown anti-torque system. The main rotor assembly 12 includes a plurality of rotor blade assemblies 22 mounted to a rotor hub 20. The main rotor assembly 12 is driven about an axis of rotation A through a main gearbox (illustrated schematically at T) by one or more engines E. Although a particular helicopter configuration is illustrated and described in the disclosed embodiment, other configurations and/or machines, such as high speed compound rotary wing aircrafts with supplemental translational thrust systems, dual contra-rotating, coaxial rotor system aircrafts, tilt-rotors and tilt-wing aircrafts, and fixed wing aircrafts, will also benefit from embodiments of the invention.

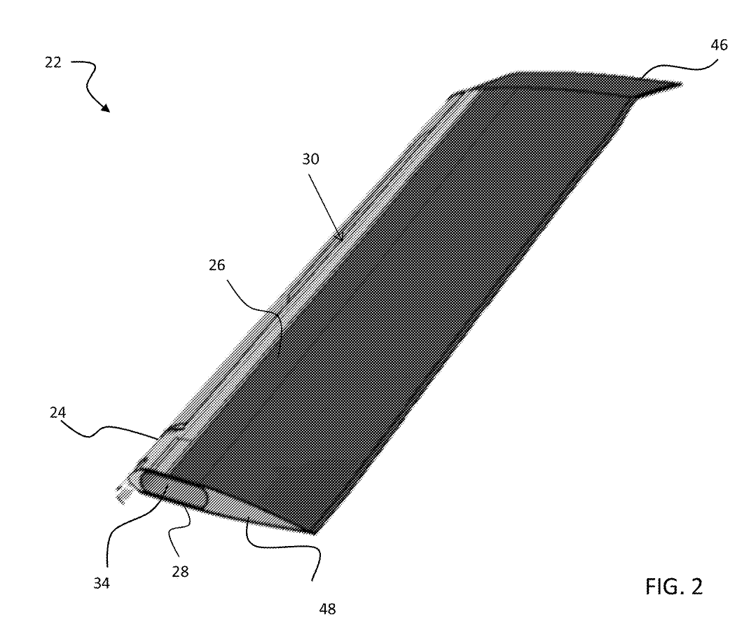

Referring now to FIG. 2, an example of one of the plurality of rotor blade assemblies 22 of the rotary wing aircraft 10 is illustrated in more detail. As shown, a heater mat assembly 30 is positioned around a portion of the rotor blade where ice frequently accumulates, such as the leading edge 24 of the blade assembly 22 for example. With respect to the span of the rotor blade 22, the heater mat assembly 30 may extend over the majority of the length of the leading edge 24 or over only a portion of the length of the leading edge 24. In addition, the heater mat assembly 30 may wrap around the leading edge 24, such as from adjacent an upper surface 26 of rotor blade 22 to a substantially opposite lower surface 28 of the rotor blade 22. The wrap angle of the heater mat assembly 30 about the leading edge 24 may be between about 0 and about 180 degrees for example.

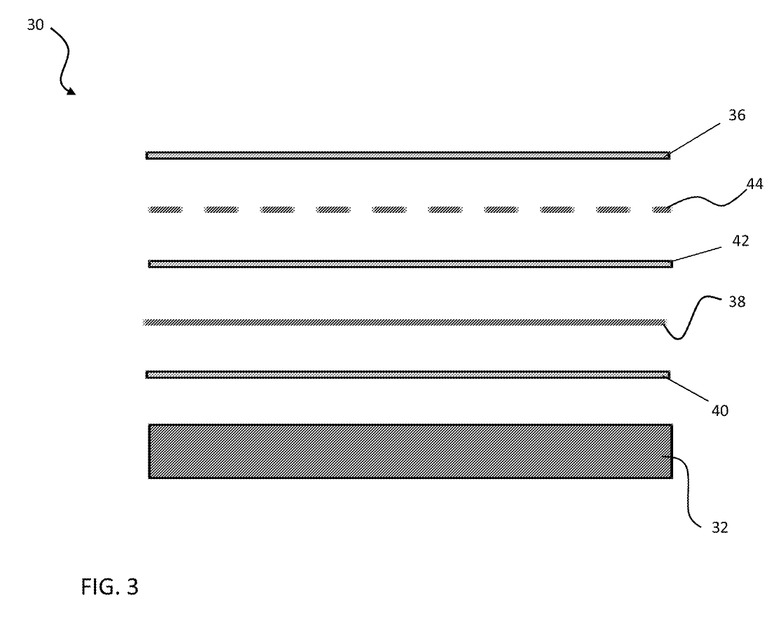

An exploded schematic diagram of an example of the heater mat assembly 30 is illustrated in more detail in FIG. 3. Although the heater mat assembly 30 is illustrated and described with respect to a rotor blade 22 of a rotary wing aircraft 10, the heater mat assembly 30 may be used in a variety of applications to selectively heat a surface where ice typically accumulates. As shown, the portion of the rotor blade 22 to which the heater mat assembly 30 is mounted, such as upper surface 26 or lower surface 28 for example, is illustrated as the innermost layer 32. In one embodiment, layer 32 may be a portion of a blade spar 34 (FIG. 2) used as the structural foundation for the rotor blade assembly 22. The outermost layer 36 of the heater mat assembly 30 includes a metal erosion strip, such as formed from titanium, nickel, stainless steel, or another erosion-resistant material. However, it is understood that the outmost layer 36 need not include the erosion strip in all locations of the heater mat assembly 30, such as in locations off the leading edge or at the mid-chord of the shown blade 22. Further, the erosion strip need not be included in the heater mat assembly 30 in all aspects of the invention.

Arranged generally centrally between the inner and outer layers 32, 36 of the heater mat assembly 30 is a heating element 38. The heating element 38 is separated from each of the inner and outer layers by an insulating layer 40, 42. The insulating layer 40 between the heating element 38 and the innermost layer 32 may, but need not be, formed from the same material as the insulating layer 42 between the heating element 38 and the outermost layer 36. An example of a material of one or both of the insulating layers 40, 42 includes a woven glass epoxy composite. In addition, the insulating layer 42 may be attached to the adjacent metal erosion strip 36 by a layer of epoxy or another adhesive 44. One or more or the layers of the heater mat assembly 30, such as the outermost layer 36, the insulating layer 42, and the adhesive layer 44 for example, may be co-cured during manufacturing or during assembly in the field.

In one embodiment, the heating element 38 of the heater mat assembly 30 comprises a layer formed from a plurality of connected carbon nanotubes. The term “carbon nanotube” or CNT includes single and multiwall carbon nanotubes and may additionally include bundles or other morphologies. The carbon nanotubes within the heating element 38 may be substantially similar, or alternatively, may be different. The plurality of carbon nanotubes may be connected by electrical terminals to allow the flow of an electrical current across the layer 38. It should be understood that the electrical current may be provided from any of a plurality of sources and may include three phase with common junction point.

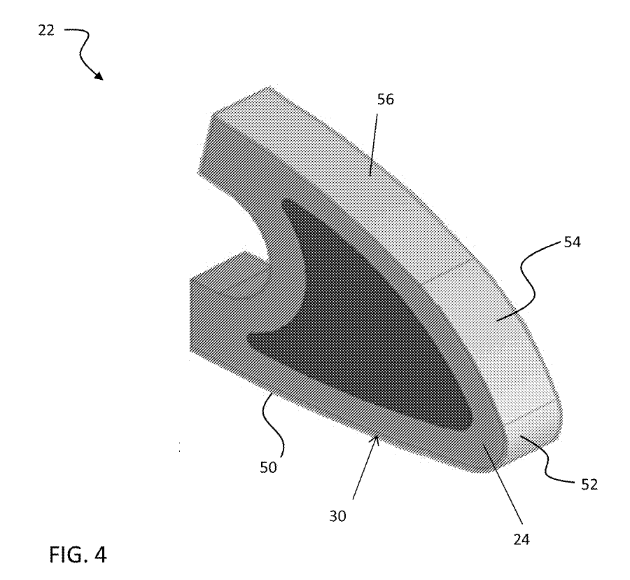

Depending on the construction of the heating element 38, the heat generated by the heating element 38 may be configured to vary across the span and the chord of the rotor blade 22. In some applications, the spanwise air speed variation that occurs at the leading edge 24 of a rotor blade assembly 22 impacts the convective heat transfer at the blade surface such that a greater amount of heat transfer occurs adjacent the blade tip 46 than near the blade root 48 (FIG. 2). In one embodiment, the heating element 38 may be configured with one or more regions or zones, such as shown in FIG. 4 for example, to accommodate the variance in heat transfer across the blade 22 that occurs due to the span-wise heat transfer variation. More specifically, the heating element 38 may be configured to generate a higher or greater amount of heat at the blade tip 46 than at the root 48 by varying its resistance along the span of the blade 22. Alternatively, or in addition, the resistance of the heating element 38 may vary to provide a necessary amount of heat to the most critical areas of the blade 22, for example where the most severe ice formation occurs. The resistance of the heating element 38 may be controlled by varying the resistance of each CNT individually, or by controlling an overall size, including width, length and number of layers formed within each region.

In the illustrated, non-limiting embodiment of FIG. 4, the partial cross-section of the rotor blade 22 having a heater mat assembly 30 includes four distinct zones. A first zone 50 is arranged adjacent a lower surface 28 of the rotor blade 22, a second zone 52 curves around a portion of the leading edge 24 of the rotor blade 22, a third zone 54 is arranged adjacent the second zone 52 and extends over a portion of the leading edge 24, and a fourth zone 56 extends from adjacent the third zone 54 over an upper surface 26 of the rotor blade assembly 22. Although a heating element 38 having four distinct zones is illustrated and described herein, embodiments having any number of zones are within the scope of the invention. Each of the zones may extend over only a portion, or alternatively, over the entire span of the rotor blade 22. One or more of the zones of the heating element 38 may be configured to generate a different amount of heat. For example, the second zone 52, or the portion of the heating element 38 partially wrapped around the leading edge 24 adjacent the lower surface 28, may be configured to produce more heat.

A heater mat assembly 30 having a heating element 38 formed from a layer of carbon nanotubes is lightweight and may have improved durability over existing metallic heating systems. In addition, because variation in the resistance of the heating element 38 may be tailored based on the needs of the rotor blade 22, the energy consumption required to de-ice the rotor blade 22 is reduced. In addition, by monitoring any changes in the resistance of the heating element 38, the heating element 38 may be used to detect locations of the rotor blade 22 where impact damage has occurred.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. By way of example, aspects of the invention could be used in propellers, wind turbine blades, building structures having a deicing need (such as gutters or edges of high rise buildings). Additionally, while various embodiments of the invention have been described, it is to be understood that aspects of the invention may include only some of the described embodiments. By way of example, aspects can be used in wind turbines, propellers used on fixed wing aircraft, or surfaces where a heater mat is being used to prevent ice buildup. Accordingly, the invention is not to be seen as limited by the foregoing description, but is only limited by the scope of the appended claims.

1. A heater mat assembly for a blade using an electrical current, the heater mat assembly comprising:
a first heating element region being configured to generate a first amount of heat using the electrical current and disposed at a first region of the heater mat assembly; and
a second heating element region extending from the first heating element region and being configured to generate a second amount of heat using the electrical current, the second amount of heat being different than the first amount of heat.

2. The heater mat assembly according to claim 1, wherein the first heating element region has a first resistance and the second heating element region has a second resistance, the second resistance being different than the first resistance.

3. The heater mat assembly according to claim 1, wherein heat generated by the first and second heating element regions is configured to vary over at least one of a span and chord of the blade.

4. The heater mat assembly according to claim 1, wherein the first and second heating element regions are formed from a plurality of connected carbon nanotubes.

5. The heater mat assembly according to claim 1, further comprising an insulating layer which separates the first and second heating elements regions from a portion of the blade spar to which the heater mat assembly is attachable.

6. The heater mat assembly according to claim 5, wherein the insulating layer is a woven glass/epoxy composite.

7. A rotor blade assembly comprising:
a rotor blade including a rotor blade spar; and
a heater mat assembly secured about a leading edge of the rotor blade and operated via an electrical current, the heater mat assembly including:
a first heating element region configured to generate a first amount of heat using the electrical current and disposed at a first region of the heater; and
a second heating element region extending from the first heating element region and being configured to generate a second amount of heat using the electrical current, the second amount of heat being different than the first amount of heat.

8. The rotor blade assembly according to claim 7, wherein the first heating element region has a first resistance and the second heating element region has a second resistance, the second resistance being different than the first resistance.

9. The rotor blade assembly according to claim 7, wherein heat generated by the first and second heating element regions is configured to vary over at least one of a span and chord of the blade.

10. The rotor blade assembly according to claim 7, wherein the first and second heating element regions are formed from a plurality of connected carbon nanotubes.

11. The rotor blade assembly according to claim 7, further comprising:
an insulating layer which separates the first and second heating elements from a portion of the blade spar to which the heater mat assembly is attachable.

12. The rotor blade assembly according to claim 7, further comprising:
a metal erosion strip; and
an insulating layer disposed between the heating element and the metal erosion strip.

13. The rotor blade assembly according to claim 12, wherein an adhesive is configured to couple the insulating layer to an adjacent surface of the metal erosion strip.

14. The rotor blade assembly according to claim 11, wherein the insulating layer is a woven glass/epoxy composite.

15. An aircraft comprising the rotor blade assembly according to claim 7.
